(19) United States
(12) Patent Application Publication
(10) Pub. No.: US 2023/0279240 A1
(43) Pub. Date: Sep. 7, 2023

(54) MELAMINE- AND BLOWING AGENT-FREE INTUMESCENT COMPOSITIONS CONTAINING GALLOYL MOIETIES

(71) Applicant: CASE WESTERN RESERVE UNIVERSITY, Cleveland, OH (US)

(72) Inventors: Erik PRICE, Cleveland, OH (US); Gary WNEK, Cleveland, OH (US); James COVELLO, Cleveland, OH (US)

(21) Appl. No.: 18/116,570

(22) Filed: Mar. 2, 2023

Related U.S. Application Data
(60) Provisional application No. 63/315,551, filed on Mar. 2, 2022.

(51) Int. Cl. C09D 5/18; C09D 7/61; C09D 7/63; C09D 163/00

(52) U.S. Cl. CPC C09D 5/185; C09D 7/61; C09D 7/63; C09D 163/00

(57) ABSTRACT

An intumescent coating composition consisting of a binder system and a two-component intumescent package is described. Tannic acid (TA) and ammonium polyphosphate (APP) have exhibited sufficient characteristics to serve as char formers (via TA), blowing agents (via TA), and an acid source (via APP). Such compositions may be incorporated in epoxy and other resin-based coatings. The resulting composition should provide comparable intumescent performance in comparison to existing/available products.

### CROSS REFERENCE TO RELATED APPLICATIONS

This application claims priority to U.S. provisional patent application Ser. No. 63/315,551 filed on Mar. 2, 2022, which is incorporated by reference. U.S. patent application Ser. No. 17/889,489 filed on Aug. 17, 2022 by the same inventors, which was a national stage filing of international publication WO 2021/221762 (itself claiming priority to U.S. provisional patent application Ser. No. 62/977,520 filed on Feb. 17, 2020), is also fully incorporated by reference herein.

### TECHNICAL FIELD

The present invention relates generally to intumescent compositions and their prospective uses. More specifically, these intumescent coatings with large polyphenols including galloyl moieties, thereby producing a porous, rigid, and extremely low density intumescent foam without the need to provide blowing agents, such as melamine and melamine-based derivatives.

### BACKGROUND

In the last fifty years, fire-retardant materials have become increasingly important, particularly with respect to the manufacture of consumer goods, construction materials, and other commonly used and/or mass-produced articles. Insofar as many fire-retardant materials incorporate specialized chemical compounds, it is often useful to coat the fire-retardant(s) onto a substrate rather constructing the article entirely from the fire-retardant material itself.

Fire-retardants applied to a substrate function in any combination of ways to protect the substrate. Some materials will endothermically degrade upon exposure to fires or high temperature, thereby removing heat energy from the substrate. Additionally or alternatively, fire-retardants can produce a char which acts as a thermal barrier to reduce the rate of heat transfer to the substrate. As a final mechanism, some fire retardant materials release compounds upon exposure to heat so as to dilute the combustible reactants (e.g., inert or non-combustible gases) or mop up the free radicals produced from the burning material and slow the fire growth.

Intumescent coatings are a form of passive fire protection, usually applied as a thin film, that swell many times their original thickness forming an insulation char. This acts as a barrier between the fire and substrate (such as structural steel). Intumescent coatings are often categorized according to the type of fire they are designed to provide protection against, for example, cellulosic fueled or hydrocarbon fueled fires.

Intumescent coatings are particularly utilized for application on structural steel (e.g., beams, columns, plates, etc.) and other metal structural components to prevent collapse and/or structural compromise. They also have application on bulk-heads, deck-heads, and firewalls of structures as a further protection for occupants during a fire event. These conventional intumescent coatings are typically composed of a polymeric binder, a source of acid, a charring agent, and a blowing agent.

When intumescent coatings are exposed to fire or excessive heat, the source of acid decomposes to provide an acid. The charring or char-forming agent (carbon source) reacts with the acid to form a carbonaceous char, simultaneously the blowing agent degrades to produce a non-flammable gas (e.g. ammonia). The gas evolved serves to create an expanded carbonaceous char/foam. This thick, porous, highly-insulating, nonflammable, solid foam protects the substrate it covers from incident heat.

In view of the foregoing, most conventional intumescent coatings require basic three components encapsulated in a binder/coating: (1) a char forming agent, (2) a blowing agent, and (3) and acid source. These three work through known pathways to catalyze degradation and evolve a voluminous char to protect the substrate.

At present, Jotachar JF750 from Jotun (Sandefjord, Norway) is one type of commercially available epoxy intumescent coating. Chartek 7 by Akzo Nobel (Amsterdam, the Netherlands) and Firetex M90/02 by Sherwin Williams (Cleveland, Ohio, USA) are other examples of epoxy intumescent coatings. Additional intumescent and/or fire-retardant products may be sold under these or other tradenames by each of these respective entities or other entities.

United States Patent Publications 2021/0340385; 2016/0145466; 2016/0152841; 2016/0145446; 2016/0160059; and 2015/0159368 provide examples of various intumescent compositions, their uses, and the general state of the art.

Intumescent compositions hold promise in delivering fire-safe solutions associated with the use and transportation of other combustible materials, particularly lithium-ion, lithium-polymer, and other similar types of batteries. Such batteries may be composed of a plurality of tightly packed cells, all containing flammable electrolytes and/or potentially combustible and dangerous forms of lithium. However, conventional fire-proof metal shipping containers tend to be too heavy for an airplane-based supply chain, and low-oxygen shipping vessels are too expensive. Thus, a sustainable and/or low-cost intumescent that can be deposited on a lightweight substrate would be welcome.

In any iteration of the aforementioned intumescent coatings, it would be preferable to draw on sustainable and/or non-toxic components, as current formulations may rely on compositions that may cause health and/or environmental issues. An article by Christopher Hobbs (Polymers 2019, 11, 224; https://www.mdpi.com/2073-4360/11/2/224) provides an overview of various bio-based flame retardant additives for polymers. Articles by Jenny Alongi (“Intumescence: Tradition versus novelty, a comprehensive review,” Progress in Polymer Science, vol. 51, Dec. 2015, pp. 28-73; https://www. sciencedirect.com/science/article/pii/S0079670015000702?via%3Dihub) and/or Ravindra Puri (“Intumescent coatings: A review on recent progress.” J Coat Technol Res 14, 1-20 (2017); https://doi.org/10.1007/s11998-016-9815-3) also provide insights on recent developments within this field.

Of particular note, TA has been used in bisphenol A-based epoxy resins to increase their limiting oxygen index (LOI). TA-functionalized graphene has also been mixed with ammonium polyphosphate and pentaerythritol to be coated on expanded polystyrene foam to produce a 300 μm coating with improved UL-94 rating and decreased peak heat release rate. Black wattle tannin has also been incorporated in epoxy based resins with boric acid, melamine, and a separate organophosphorus flame retardant known as DOPO (9,10-dihydro-9-oxy-10-phosphaphenanthrene-10-oxide). Thus, while tannic-acid based flame retardant polymers were known, little work has been done to develop effective, comprehensive, and bio-based intumescent systems based solely on tannic acid (notably, such systems are deposited as coatings but also include components to promote suppression of flammable conditions and formation of robust, insulating char).

International Patent Publication WO2021221762A2, also pending as United States Patent Application PCT/US2021/0183343 filed on Feb. 21, 2021, was published by the inventors and is, therefore, incorporated by reference to its fullest extent (including any claim of priority). This publication discloses an intumescent composition relying upon tannic acid in combination with blowing agents to produce robust, low-density carbon foams that may be appropriate as intumescent compositions.

In view of the foregoing, there is a need for light-weight, cost-effective, and easy to produce intumescent compositions. In particular, a formulation that is based at least partially on bio-sourced components that can serve as an intumescent composition without the need for blowing agents would be welcome.

### SUMMARY OF INVENTION

The claims, drawings, and description all disclose elements and aspects of the invention. While specific embodiments may be identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

The drawings illustrate various aspects of the invention and its benefits. All of the data shown in any graph is specifically disclosed and incorporated by reference, so as to provide written description of those details. Similarly, skilled persons may infer ratios, extrapolations, or other relationships from these data, and all of these form further aspects of this written description.

In the drawings:

FIG. 1 is a plot of temperature over time for various intumescent coatings' performance under fire conditions, with experiments having been performed in triplicate so that the shaded areas of each solid line represent intervals of confidence. Commercial industrial coating (PER) and melamine containing coating (SI) represent conventional formulations, while the novel formulation embodying aspects of this invention are also shown (SI-MEL)

FIG. 2 is a comparative plot of the “elastic” region of the char (i.e., its load vs. strain capabilities) for two separate aspects of the invention, with an improved formulation (82) compared to a melamine containing coating (SI, also referenced in FIG. 1).

### DETAILED DESCRIPTION

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Table A indicates information about the specific compositional constituents referenced in this disclosure.

TABLE A
Acronyms and chemical structures.

| Compound | Structure | Abbreviation |
|---|---|---|
| Ammonium polyphosphate | 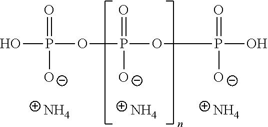 | APP |
| Melamine | 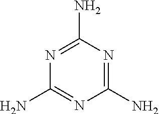 | MEL |
| Pentaerythritol | 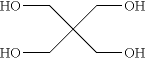 | PER |
| Tannic acid | 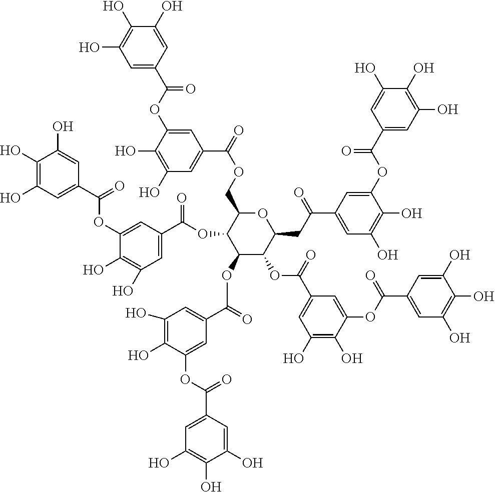 [SMILES: O=C(C[C@@H]1O[C@H](COC(=O)c2cc(O)c(O)c(OC(=O)c3cc(O)c(O)c(O)c3)c2)[C@@H](OC(=O)c2cc(O)c(O)c(OC(=O)c3cc(O)c(O)c(O)c3)c2)[C@H](OC(=O)c2cc(O)c(O)c(OC(=O)c3cc(O)c(O)c(O)c3)c2)[C@H]1OC(=O)c1cc(O)c(O)c(OC(=O)c2cc(O)c(O)c(O)c2)c1)c1cc(O)c(O)c(OC(=O)c2cc(O)c(O)c(O)c2)c1] | TA |
| Gallic acid | 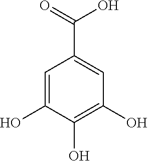 [SMILES: O=C(O)c1cc(O)c(O)c(O)c1] | GA |

As a preliminary matter, all of the aforementioned patent publications are incorporated by reference as if fully rewritten herein. In particular, these disclosures provide further information on the state of the art and the types of resins, curing agents, and additives commonly found in binder systems that can be combined with the two-part intumescent package described and/or claimed below. These disclosures also inform potential substitutions and/or modifications that may be possible without departing from these inventive concepts.

APP is an inorganic salt of phosphoric acid and ammonia in the form of a low-branching chain. When APP is heated to 250° C. it begins to decompose. This decomposition creates gaseous ammonia and polyphosphoric acid. The polyphosphoric acid catalyzes a reaction between two hydroxyl groups on the char-forming molecules (and the degraded binder to a lesser extent), forming an ether link while simultaneously releasing water as a byproduct. This also regenerates the phosphoric acid catalyst. This reaction evolves gaseous water as a blowing agent and helps to dilute the combustible oxygen of the air. Additionally, at higher temperatures, the crosslinking that occurs often incorporates phosphorous linkages, structurally bolstering the resultant char.

Melamine is a nitrogen rich trimer of cyanamide commonly found in polymer production and fertilizer. MEL decomposes almost entirely at 360° C., evolving up to 80% of its mass as nitrogen gas. The large quantity of nitrogen gas displaces oxygen and combustible degradation products in order to remove them from the combustion atmosphere, as well as expanding char barrier outwards. The high ratio of evolved gas per mol of MEL make this compound a very efficient blowing agent. In fact, melamine is ubiquitous in modern intumescent coatings to the extent that many modern review articles forego any discussion of alternative blowing agents. However, a recent proposal has been put forward to harmonize the classification of melamine as carcinogenic under REACH/CLP. If adopted, this proposal would make melamine-based coatings undesirable.

Recent innovations in intumescent coatings suggest a composition of ammonium polyphosphate (APP) as the acid source, melamine (MEL) as the blowing agent, and pentaerythritol (PER) and/or tannic acid (TA) as the char forming agent, with each of these components provided in significant amounts (i.e., at least 10 wt. %, with melamine sometimes comprising as much as. Other popular formulations may rely on boric acid, which delivers synergistic effects by serving as an acid source, a cooling agent, and a facilitator in char formation; however, boric acid is currently garnering regulatory attention owing to its potential environmental and health impacts. Various other formulations of intumescent coatings might use other additional or alternative components in the intumescent forming components (i.e., the non-binder system), but these tend to add cost, complexity, and/or entail other complicating factors. Therefore, the inventors endeavored to formulate a cost-effective, simplified intumescent that can be compatible with any number of binder systems.

To that end, the inventors recognized that tannic acid (also referred to as TA or polyphenol of, under IUPAC nomenclature, 1,2,3,4,6-penta-O-{3,4-dihydroxy-5-[(3,4,5-trihydroxybenzoyl)oxy]benzoyl}-D-glucopyranose according to CAS number 1401-55-4) is already a known char forming agent used as an additive or replacement for PER (e.g., see international patent publication no. 2021/221762). TA is a large tannin-based polyphenol commonly found in the skin of grapes and/or various species of trees and plants, thereby providing potentially sustainable bio-source. Tannic acid contains abundant hydroxyl groups arranged in a loosely radial configuration, making it very attractive for forming a carbonaceous barrier. The structure and placement of these hydroxyl groups cause tannic acid to form a graphene-like char via etherification upon combustion.

Notably, TA has the general chemical formula C₇₆H₅₂O₄₆ and a molecular weight of about 1701 g/mol. Its structure includes ten separate phenol-based rings connected by various ether and/or ester based connections. Thus, the broadest category of TA-containing compounds that may be appropriate for use in various aspects of this invention include any naturally derived phenolic molecules. This specifically includes neutralized versions of TA, as well as other common substitutions and derivatives based upon the original TA structure. Further, TA and TA-containing derivatives encompass fully or partially neutralized versions, where the ionic species include any combination of alkali metals, alkaline earth metals, and/or selected transition metals, as well as aluminum (+3).

Now, the inventors propose a TA-APP formulation for intumescent coatings that does not contain melamine or any dedicated blowing agent. Instead, by providing large polyphenols with abundant galloyl moieties (i.e. tannins, catechin, tannic acid, gallic acid (GA), and further derivatives thereof), polyphenol (TA) and ammonium polyphosphate (APP), a common fertilizer and food additive, can be encapsulated in a binder in order deliver an intumescent coating and system. The system degrades in the presence of heat/fire, resulting in an expanding char which protects the substrate with the same efficacy as commercial coatings.

This invention represents an improvement over previous technology in that it (1) does not contain the blowing agent melamine which is known to be harmful, (2) contains two components as opposed to the three component systems currently used, (3) represents a “green” intumescent system which can be derived from biomass, and (4) offer equivalent or superior fire protection in comparison to the three component systems.

The inventors have provided for an intumescent system consisting of only two primary components held in a binder: (1) a polyphenol source (i.e. tannins) and (2) an acid source. The inventors discovered the acid source can catalyze carbonization of the polyphenol to produce amounts of gas comparable to a dedicated blowing agent, thereby eliminating the need for melamine. The acid simultaneously catalyzes the polyphenol to degrade into a planar carbon structure with excellent heat blocking capability. The absence of melamine alone is considered advantageous.

Ammonium polyphosphate and its derivatives are envisioned as an ideal acid source because its degradation mechanism is well known. Additionally, the inventors believe it exhibits synergistic properties with polyphenols.

Binders and binder systems are well-known in the intumescent field. While two-part epoxies are expected to be the most useful, other systems could be substituted while still realizing the benefits of the tannic acid-ammonium polyphosphate combination. In the same manner, it may be possible to rely on derivatives of these two main components without departing from the underlying invention, so long as the TA and/or GA derivatives serve both as the charring agent and the blowing agent, while the APP derivatives prove to be an adequate acid source. Further, it will be understood that the binder systems in all aspects of the invention do not possess melamine, its derivatives, boric acid, its derivatives, or any other additive that is intentionally selected to deliver or enhance the intumescent effects provided by TA/GA and APP.

Sustainability is a consideration of growing importance for commercially competitive intumescent coatings. In this regard, tannic acid can be derived from many plants (e.g., grapes, oak gall, etc.), so as to render it an excellent candidate for a bio-sourced char forming agent. Ammonium polyphosphate may be produced on an industrial scale for use as fertilizer. It is generally prepared from the mineral hydroxyapatite but can be found in large quantities in bone mineral of vertebrates, also making it a potentially bio-sourced component. The binding agent used for experimentation was two-part epoxy but other, more renewable, binders should be able to reach similar levels of performance.

Generally speaking, the binder system will constitute approximate one half, by weight, of the intumescent coating. Such binders can include epoxy resins coupled with amine curing agents. Other binders are also possible.

The intumescent package will consist of only two components, a tannic acid component (consisting of tannic acid and/or its derivatives, containing galloyl moieties) and an ammonium polyphosphate component (consisting of ammonium polyphosphate and/or its derivatives). These components will be admixed and dispersed within the binder system so as to surround and incapsulate the intumescent components, which will only activate upon exposure to fire, combustion, or extreme heat, As a result, once the intumescent coating cures, a generally uniform coating (in terms of both composition and thickness) is attained.

Resin-based binder systems (with curing agents, where appropriate) capable of producing uniform coatings, preferably between several micrometers up to several millimeters thick, are of particular interest. The binder system might form anywhere between 25 to 75 wt. % of the overall composition, although it will be understood that there are advantages to prioritizing and maximizing the amount and/or the efficacy of the intumescent components. Any number of conventional binder systems may be employed, including those based on epoxies, amines, amides, acrylics, vinyl esters silicones, polyurethanes, polysiloxanes, polyurea, ketones, unsaturated polyesters, acrylates vinyl acetates, methacrylates and derivatives thereof and the like. The resins could be thermoplastic or thermoset. The resultant coatings produced by the binder system (when loaded with/encapsulating the intumescent package) can be applied to and cured on articles and/or structures.

In one aspect, an amine-based curing agent is coupled with one or more epoxy resins to form the binder. Epoxy and amine-curing agent are provided in complimentary amounts, with the mass of curing agent usually similar to or slightly less than the mass of epoxy. In certain formulations, the epoxy will be between 10 to 35 wt. % and the amine curing agent between about 5 to 30 wt. % and more ideally about 20 to 30 wt. % epoxy and 12 to 22 wt. % amine curing agent (the preferred mass ratio of epoxy to amine curing agent may be between 1.3:1 and 1.6:1 with the ideal range of about 1.45:1). Ultimately, the amount binder should be sufficient to mix with the tannic acid component and the ammonium phosphate component, so as to adhere the entire composition to the desired substrate. It will also be understood that the ratio of resin to curing agent may vary within certain preferred ranges that depend upon the specific characteristics and composition of those components.

The binder system may also include optional additives, such as pigments, diluents, plasticizers, fillers (e.g., waxes, clays, inorganics, etc.), and/or catalysts. However, in all cases, the binder system will be completely free of melamine, derivatives of melamine, and/or other components that are intentionally selected to act as blowing agents. Also, the binder system will not contain any boric acid or boric acid derivatives.

In some aspects, the tannic acid is provided at between 10 to 50 wt. % or between about 20 to 25 wt. % of the total weight of the coating composition (including the binder system). Taking into account the weight percentages for the binder systems noted above, he ammonium polyphosphate will fill out the balance of the composition. As noted above, no further components (particularly, blowing agents such as melamine and/or additives/alternative acid sources such as boric acid) are needed or provided to the intumescent package (i.e., the acid source, APP, and the dual char former/blowing agent, TA). Insofar as the tannic acid and the ammonium phosphate are solely responsible for the intumescent properties of the coating system (i.e., formation of an expanded, insulating char upon fire/heating), it is desirable to maximize the weight percentages of these components while still providing sufficient amounts of binder system to form a coating on the article or structure in need of intumescent protection.

### EXAMPLES

Experiments were conducted by:
Creating a coating of the system as detailed above.
Applying 16.5 g of the coating to a 5″×5″ cardboard square.
Exposing the square to a meeker torch at a range of 3″.
Thermocouple 1 (x-1) was placed inside the cardboard panel
Thermocouple 2 (x-2) was secured to the uncoated face with tape.
All testing was captured on video.

Videos of the cardboard protection experiments were analyzed in profile to capture char volume over time. It was found that all samples reached peak intumescence around 180 seconds and achieved a volume around 1800 seconds which held constant until failure. Compression testing was done on char produced by torch exposure for these periods. Testing was done by lowering the compressive plates onto the char at a constant strain rate and measuring the amount of force (N) needed to crush the char at different degrees of compression. Pine substrates were used due to their known compatibility with the system and well defined compressive modulus that falls outside the expected range for the char.

Compression data confirms our observations that the melamine free char is more rigid. This appears to be consistent across several trials, across all strains, at both degrees of combustion. Advantageously, a more rigid char might be less likely to become displaced from the coating during an erosive fire, thereby sustaining the intumescent efficacy in comparison to melamine-based compositions.

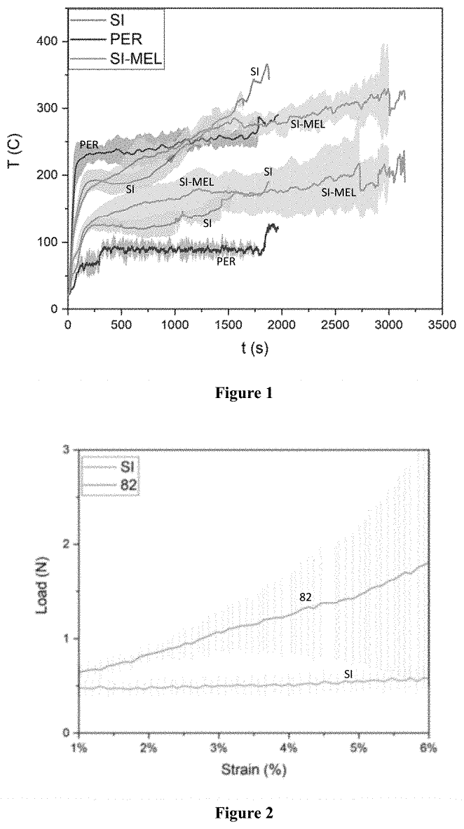

TABLE
Comparison of char compressive strengths at different points during
combustion and under different strains. Also reference FIG. 1, insofar
as the sample designations for FIG. 1 apply to the formulations above.

| | Force to | Force to |
|---|---|---|
| | Compress at 10% | Compress at 40% |
| Sample | Compression (N) | Compression (N) |
| SI @ 180 s (contains MEL) | 0.7 | 10.5 |
| SI-MEL @ 180 s | 2.5 | 19.4 |
| SI @ 3000 s (contains MEL) | 2.6 | 5.0 |
| SI-MEL @ 3000 s | 3.0 | 12.5 |

Furthermore, analysis of the first 5% of the compression curves can give us a rough approximation of the “elastic modulus” of these chars. From this we can see that the compressive modulus is larger for the new formulation. This implies that it will be tougher and more robust in actual fire scenarios.

FIG. 2 provides further insights on the specifics of other aspects/formulations of the invention. In all instances (the Table and FIGS. 1 and 2), only a two component intumescent, having TA and APP (along with an appropriate binder system), were used for those samples indicated as being aspects of the invention.

In various aspects of the invention, an intumescent coating composition and, in some cases, a liquid intumescent coating composition may include any combination of the features explicitly disclosed, implicitly understood, or otherwise embraced herein.

Generally speaking, chemical components and related constituent items should also be selected for workability, cost, and weight. Unless specifically noted, all tests and measurements are conducted in ambient conditions and relying upon commercially available instruments according to the manufacturer-recommended operating procedures and conditions. Unless noted to the contrary (explicitly or based upon the context), all measurements are in grams and all percentages are based upon weight percentages and weight average molecular weights.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. An intumescent coating composition consisting of:
a tannic acid component;
an ammonium polyphosphate component;
a polymeric binder system; and
wherein, upon curing of the polymeric binder system, the tannic acid component and the ammonium polyphosphate component are encapsulated within a coating formed by the polymeric binder system.

2. The composition of claim 1 wherein the polymeric binder system is a two-part epoxy binder.

3. The composition of claim 2 wherein the tannic acid component consists essentially of tannic acid and the ammonium phosphate component consists essentially of ammonium phosphate.

4. The composition of claim 1 wherein the tannic acid component is between 10 to 50 wt. %, the polymeric binder system is between 15 to 65 wt. %, and the ammonium polyphosphate component forms a remaining weight of the composition.

5. The composition of claim 4 wherein the polymeric binder system consists essentially of one or more epoxy resins and a curing agent.

6. The composition of claim 5 wherein the epoxy resins comprise between 10 to 35 wt. % of the composition.

7. The composition of claim 1 wherein the polymeric binder system does not contain any constituents that evolve nitrogen gas when the cured composition is exposed to fire.

8. The composition of claim 1 wherein the tannic acid component consists of a polyphenol having a single central ring structure including one carbon atom and five carbon atoms, each of said five carbon atoms having a pendant group extending therefrom, and wherein every pendant group terminates with a galloyl moiety.

9. An intumescent coating composition consisting of tannic acid, ammonium polyphosphate, and a binder system having a polymeric resin, a curing agent, and optional coating system additives and wherein the composition does not contain any of: melamine, melamine derivatives, boric acid, and boric acid derivatives.

10. The composition of claim 9 wherein the binder system does not contain any additives.

11. The composition of claim 9 wherein the polymeric resin is an epoxy resin and the curing agent contains an amine.

12. A method of fireproofing an article or structure, the method comprising:
encapsulating an intumescent package consisting of a tannic acid component and an ammonium phosphate component within a resin-based binder system to form a coating composition and wherein the resin-based binder system does not contain any combination of melamine, melamine derivatives, and components that evolve sufficient gas upon exposure to fire so as to serve as a blowing agent for the intumescent package;
applying the coating composition to a substrate; and
curing the coating composition.

13. The method of claim 12 wherein the tannic acid component is tannic acid.

14. The method of claim 12 wherein the ammonium phosphate component is ammonium phosphate.
